(19) United States
(12) Patent Application Publication
(10) Pub. No.: US 2013/0111267 A1
(43) Pub. Date: May 2, 2013

(54) OPTIMIZING REGRESSION TESTING BASED ON CODE COVERAGE ANALYSIS

(71) Applicants: Dmitriy BERYOZA, Ottawa (CA); Hendrik CAZEMIER, Spencerville (CA); David C. CUMMINGS, Ottawa (CA); Joseph P. FOURNY, Ottawa (CA); Robin N. GROSSET, Ottawa (CA); Roch LEFEBVRE, Gatineau (CA); Richard PIGEON, Gatineau (CA); Glen M. SEEDS, Nepean (CA); Qing WEI, Ottawa (CA)

(72) Inventors: Dmitriy BERYOZA, Ottawa (CA); Hendrik CAZEMIER, Spencerville (CA); David C. CUMMINGS, Ottawa (CA); Joseph P. FOURNY, Ottawa (CA); Robin N. GROSSET, Ottawa (CA); Roch LEFEBVRE, Gatineau (CA); Richard PIGEON, Gatineau (CA); Glen M. SEEDS, Nepean (CA); Qing WEI, Ottawa (CA)

(73) Assignee: INTERNATIONAL BUSINESS MACHINES CORPORATION, Armonk, NY (US)

(21) Appl. No.: 13/286,997

(22) Filed: Nov. 1, 2011

(51) Int. Cl. G06F 11/28

(52) U.S. Cl. 714/32; 714/E11.178

(57) ABSTRACT

Provided are techniques for improving a test suite. A list of tests in a test suite is created, sorted in order of increasing run time, wherein multiple tests having a same run time are sorted in order of decreasing code block coverage. For each test on the list, it is determined whether the test covers one or more code blocks not already covered by at least one previously processed test. In response to determining that the test does cover one or more code blocks not already covered by the at least one previously processed test, the test is added to an optimized test suite. The optimized test suite is stored.

### BACKGROUND

Embodiments of the invention relate to optimizing regression testing based on code coverage analysis.

Regression testing may be described as code testing that tries to identify new errors, or regressions, in existing functionality after changes have been made to the code.

In software development projects, code is continually tested with a test suite that provides a high degree of code coverage (i.e., the test suite tests most or all of the code).

This helps maintain high quality of the code and ensures that code changes do not break or alter existing functionality in unexpected ways.

Modern software best practices recommend that unit tests are run often during development, or at the very least are run once before a set of changes are committed to the official component code stream.

A commonly used rule of thumb in development is to have a set of tests that runs in under ten minutes so that this is not disruptive to the development process and does not discourage developers from running tests often. Occasionally, the nature of the project makes it difficult to make all tests lightweight (e.g., running quickly, such as in ten minutes). For example, tests may be exercising code that accesses slow performing resources, such as network resources, databases, large files, etc. Sometimes developers try to speed execution up by replacing such resources with fast-performing “mock ups”.

Thus, developers want to continuously test code, while having the tests complete in a reasonable amount of time, even for slow performing resources.

Some systems try and reduce the test suite size without decreasing code coverage. With the code and tests constantly changing, this analysis has to be done continuously.

### SUMMARY

Provided are a method, computer program product, and system for improving a test suite. A list of tests in a test suite is created, sorted in order of increasing run time, wherein multiple tests having a same run time are sorted in order of decreasing code block coverage. For each test on the list, it is determined whether the test covers one or more code blocks not already covered by at least one previously processed test. In response to determining that the test does cover one or more code blocks not already covered by the at least one previously processed test, the test is added to an optimized test suite. The optimized test suite is stored.

### BRIEF DESCRIPTION OF THE SEVERAL VIEWS OF THE DRAWINGS

FIG. 1 illustrates, in a block diagram, a computing environment in accordance with certain embodiments.

FIG. 2 illustrates logic, in a flow diagram, for capturing test code coverage data in accordance with certain embodiments. FIG. 2 is formed by FIGS. 2A and 2B.

FIG. 3 illustrates logic, in a flow diagram, for optimizing a test suite in accordance with certain embodiments. FIG. 3 is formed by FIGS. 3A and 3B.

FIG. 4 illustrates a graph 400 of sample test statistics in accordance with certain embodiments.

FIG. 5 illustrates logic, in a flow diagram, for reporting discarded test information in accordance with certain embodiments.

FIG. 6 illustrates, in a block diagram, a computer architecture that may be used in accordance with certain embodiments.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments provide a process of automating test code coverage analysis and reducing the test suite to improve performance.

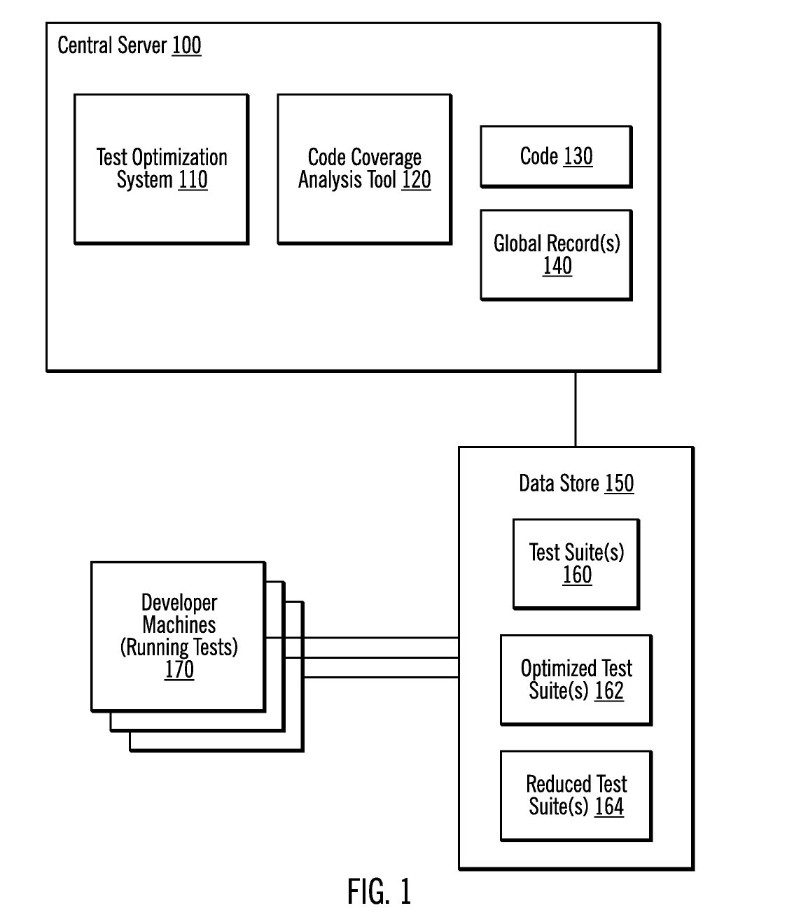

FIG. 1 illustrates, in a block diagram, a computing environment in accordance with certain embodiments. A central server 100 is coupled to a data store 150 and one or more developer machines 170. The central server 100 includes a test optimization system 110, a code coverage analysis tool 120, code 130 to be tested, and one or more global records 140.

The developer machines 170 obtain test suites from the data store 150 to test the code 130. The data store 150 stores one or more test suites 160, one or more optimized test suites 162, one or more reduced test suites 164. In certain embodiments, a reduced test suite 164 is a reduced set of tests (i.e., reduced with reference to an original test suite 160), so that the execution of the reduced test suite 164 is faster than execution of the original test suite. In certain embodiments, a reduced test suite 164 may be described as having tests that have the highest value for a given metric (i.e., the number of newly covered blocks per unit of time). In certain embodiments, the reduced test suite 164 may be described as a prioritized test suite in which the tests are prioritized (e.g., in order of number of newly covered blocks). Each of the one or more optimized test suites 162 includes tests to cover all code blocks of an application, while each of the one or more reduced test suites 164 includes tests to cover some subset of the code blocks of the application.

In certain embodiments, the test optimization system 110 is running on a separate, central server 100, continuously analyzing test suites 160 according to criteria specified by a system administrator. The test analysis does more than execute the test suite 160. The tests analysis instruments the code, and captures, analyzes, and reports on the test code coverage data. In alternative embodiments, the test optimization system 110 may run on a different computing system.

Once a test suite 160 is optimized (to form an optimized test suite 162) or reduced (to form a reduced test suite 164), the test suites 162, 164 (e.g., as test definitions) are recorded in the data store 150. The data store 150 may be described as a shared repository, such as a source control system or a file share. The test suites 162, 164 may be accessed by the developer machines 170.

In certain embodiments, a source control system is used that allows versioning of test suite definitions and synchronizes them to corresponding versions of the code, making test suites 162, 164 more relevant.

The test optimization system 110 introduces a coverage-based test suite optimization mechanism. In certain embodiments, the test optimization system 110 operates under an understanding that, for quick code change verification, it is not necessary to execute multiple combinations of paths through the code base of an application, but rather execute each block of code or some subset of blocks of code at least once. This limited testing allows the test optimization system 110 to reduce the size and running time of the test suite and is sufficient to verify that particular functionality has not been broken. A comprehensive test suite may still be run periodically or on demand to verify critical changes to the code and act a “safety net”. The combination of the optimized testing and the comprehensive testing produces productivity savings while providing overall quality of the software.

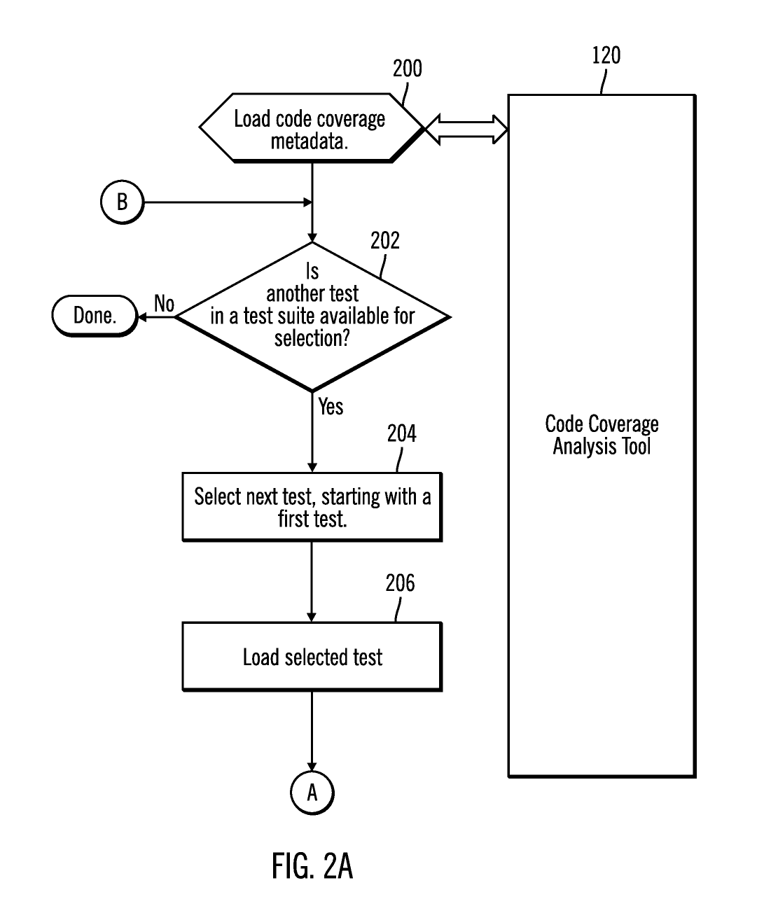

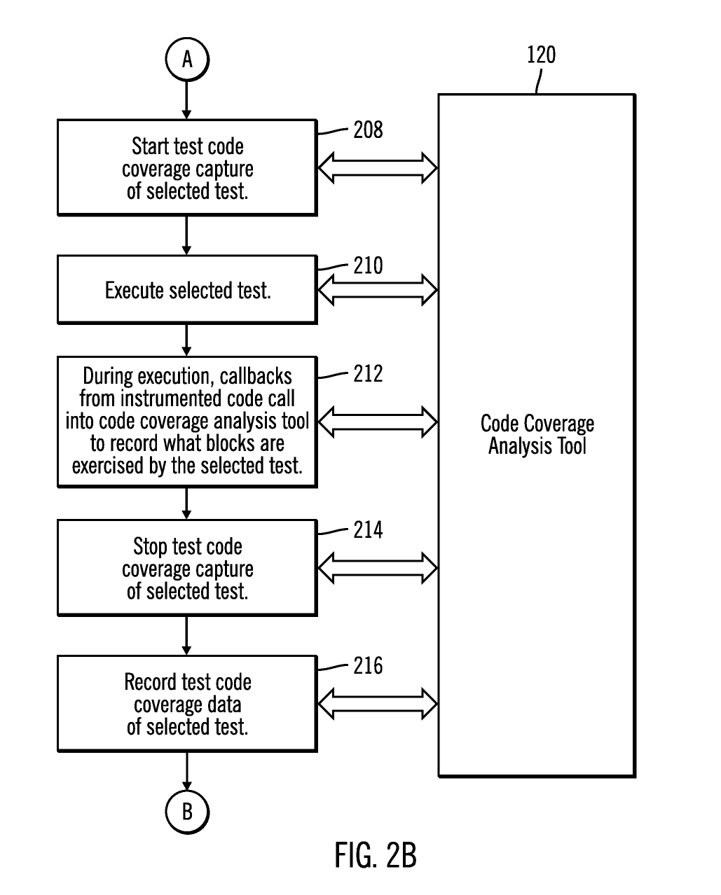

FIG. 2 illustrates logic, in a flow diagram, for capturing test code coverage data in accordance with certain embodiments. FIG. 2 is formed by FIGS. 2A and 2B. In certain embodiments, the test code coverage data may be captured using a tool, such as the code coverage analysis tool 120.

In FIG. 2, in order to capture the test code coverage data, the code has to be instrumented using the code coverage analysis tool 120, which injects special “callbacks” into the compiled code. Instrumentation may be described as inserting extra commands (i.e., callbacks) into the original application. Those commands do not pertain to or affect the intended behavior or output of the application. The commands are meant to measure, collect or expose information about the state of the application at that point in the execution.

These callbacks call into the code coverage analysis tool 120 to record the fact that a particular code block has been executed. As a result of the instrumentation, the code coverage analysis tool 120 generates a set of metadata (“code coverage metadata”) that describe the relation between code classes, methods, source lines and internal code block identifiers (IDs). The test optimization system 110 uses this code coverage meta-data to report on what code has not been covered by tests and what code is covered by tests that may not be run (e.g., because they are expensive to run).

In FIG. 2A, control begins at block 200, with the code coverage analysis tool 120 loading the code coverage metadata in order to be able to reference this code coverage metadata at run time. In certain embodiments, a test suite is loaded, and the tests are traversed one by one (blocks 202-216).

In block 202, the code coverage analysis tool 120 determines whether another test in a test suite is available for selection. If so, processing continues to block 204, otherwise, processing is done. In block 204, the code coverage analysis tool 120 selects a next test, starting with a first test. In block 206, the code coverage analysis tool 120 loads the selected test. From block 206 (FIG. 2A), processing continues to block 208 (FIG. 2B).

In block 208, the code coverage analysis tool 120 starts test code coverage capture of the selected test. In block 210, the code coverage analysis tool 120 executes the selected test. In block 212, during the execution of the selected test, callbacks from the instrumented code call into the code coverage analysis tool 120 to record what blocks are exercised by the selected test. After the execution of the selected test is complete, in block 214, the code coverage analysis tool 120 stops the test code coverage capture of the selected test. In block 216, the code coverage analysis tool 120 records the test code coverage data of the selected test. The code coverage metadata may come from several sources, in addition to the instrumented code (i.e., callbacks). Most systems do not expose enough information to monitor the invocation of classes, methods or statement blocks without the use of code such as callbacks. That is, once the test code coverage data is captured, this data is retrieved and saved for future analysis together with the test execution time. From block 216 (FIG. 2B), processing continues to block 202 (FIG. 2A).

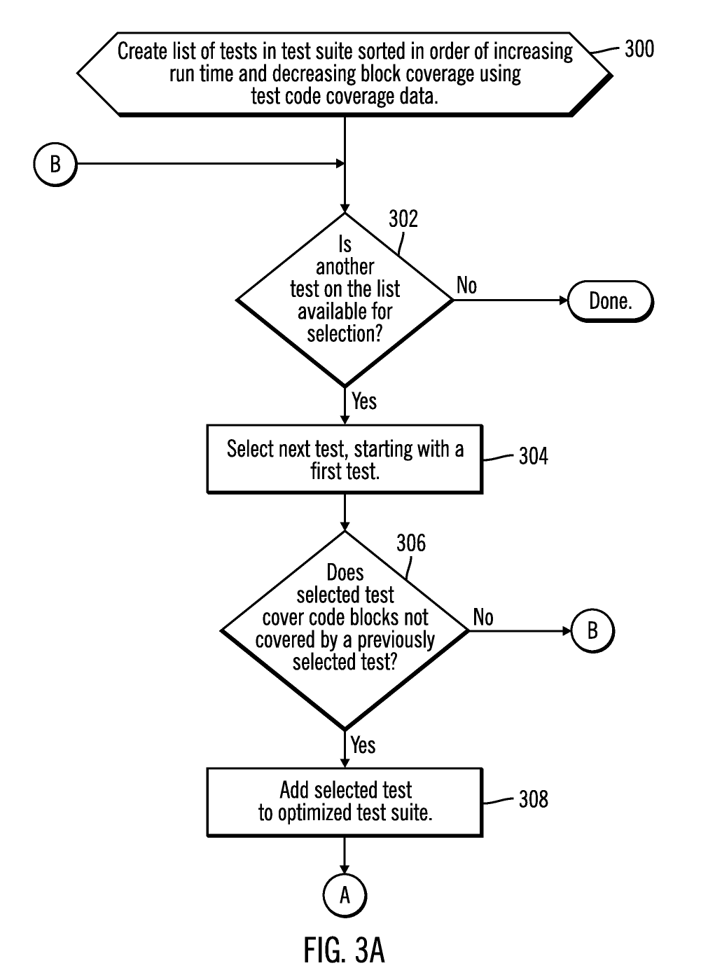

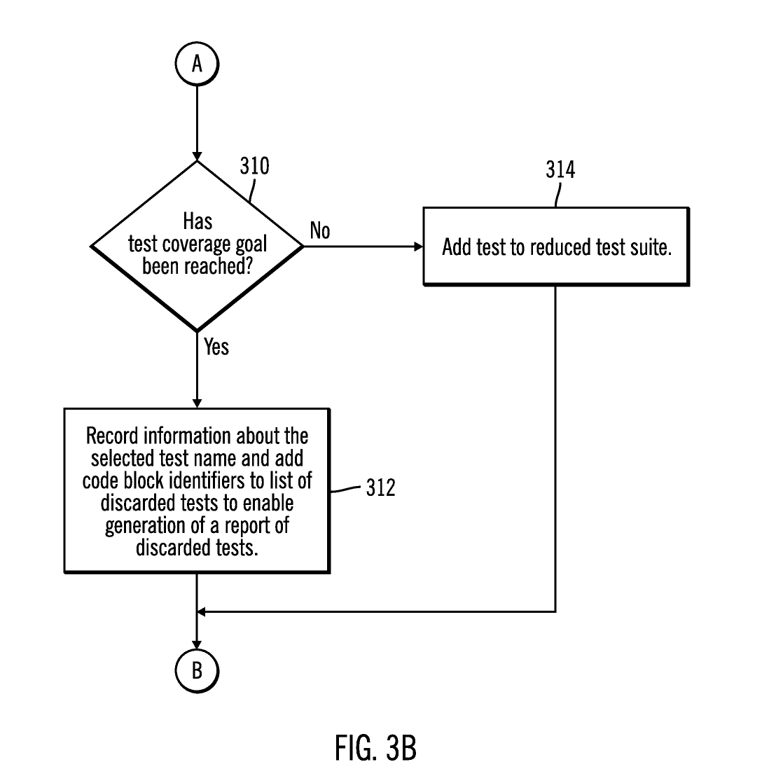

FIG. 3 illustrates logic, in a flow diagram, for optimizing a test suite in accordance with certain embodiments. FIG. 3 is formed by FIGS. 3A and 3B. Once the test code coverage data is captured, the test optimization system 110 analyzes the test code coverage data in order to reduce the overall test execution time.

In FIG. 3A, control begins at block 300 with the test optimization system 110 creating a list of tests in the test suite sorted in the order of increasing run time and decreasing code block coverage using the test code coverage data. That is, tests are sorted in the order of increasing run time, and tests that run in equal time are sorted in the order of decreasing number of covered code blocks. This allows for analyzing faster tests first because the goal is to minimize the overall test suite execution time, and then maximize the coverage per test. In certain embodiments, once the list of tests is created, the list is traversed in blocks 302-314, while keeping a global record 140 of the code blocks covered so far.

In certain embodiments, initially, the test optimization system 110 starts with an empty global record 140 and, for the first test selected, copies all code block identifiers of the code blocks covered by that selected test into this global record 140. For each successive test, the test optimization system 110 looks at the covered code blocks and checks whether all of them are already in the global record 140. If they are, the test does not contribute any new test code coverage and can be considered redundant and removed. If the test does contribute new test code coverage, those code block identifiers of the new code blocks covered by the test are copied into the global record 140, and the test remains in the optimized test suite.

In certain embodiments, the test optimization system 110 creates a copy of the test suite 160. Tests may be removed from this copy.

In block 302, the test optimization system 110 determines whether another test on the list is available for selection. If so, processing continues to block 304, otherwise, processing is done. In block 304, the test optimization system 110 selects a next test on the list, starting with a first test. Note again that the list is a sorted list, and the fastest tests that cover more code blocks are selected before the slower tests that cover fewer code blocks.

In block 306, the test optimization system 110 determines whether the selected test covers code blocks that are not already covered by a previously selected test. That is, it is determined whether the selected test covers code blocks that have not been covered by tests already processed in blocks 302-314. In certain embodiments, the determination compares code block identifiers of the code blocks covered by the selected test against the code block identifiers in the global record 140. If so, processing continues to block 308, otherwise, processing continues to block 302.

In block 308, the test optimization system 110 adds the test (with the code blocks that are newly covered) to the optimized test suite 162. From block 308 (FIG. 3A), processing continues to block 310 (FIG. 3B).

In block 310, the test optimization system 110 determines whether a test coverage goal has been reached. In certain embodiments, the test coverage goal may be set by an end user (e.g., a system administrator). If so, processing continues to block 312 (FIG. 3B), otherwise, processing continues to block 314.

In block 312, the test optimization system 110 records information about the selected test name and adds code block identifiers (of the code blocks not covered by a previously selected test) to a list of discarded tests to enable generation of a report of discarded tests. From block 312 (FIG. 3B), processing continues to block 302 (FIG. 3A).

In block 314, the test optimization system 110 adds the test to the reduced test suite 164. From block 314 (FIG. 3B), processing continues to block 302 (FIG. 3A).

Thus, the test optimization system 110 uses the test code coverage data for the retained tests to create an optimized test suite 162 and a reduced test suite 164. The test optimization system 110 also saves the test code coverage data of removed (i.e., discarded) tests for further reporting and analysis.

Merely to enhance understanding, an example will be provided. In the example, suppose test A covers code blocks 1, 2 and 3, and test B covers code blocks 1, 2 and 5. Initially, the test optimization system 110 processes test A and copies code block identifiers of code blocks 1, 2, and 3 into the global record 140. For test B, the test optimization system 110 determines that test B contributes unique coverage for code block 5, and the test optimization system 110 adds the code block identifier for code block 5 to the global record 140. Then, suppose that test C covers code blocks 1 and 2. The test optimization system 110 determines that test C is redundant and discards test C.

In certain embodiments, removing redundant tests may not be enough to meet the test coverage goal (e.g., executing in ten minutes), and the resulting test suite may still execute in a longer than desired amount of time. The test optimization system 110 provides further optimization that does not cover all code blocks, but provides faster execution time.

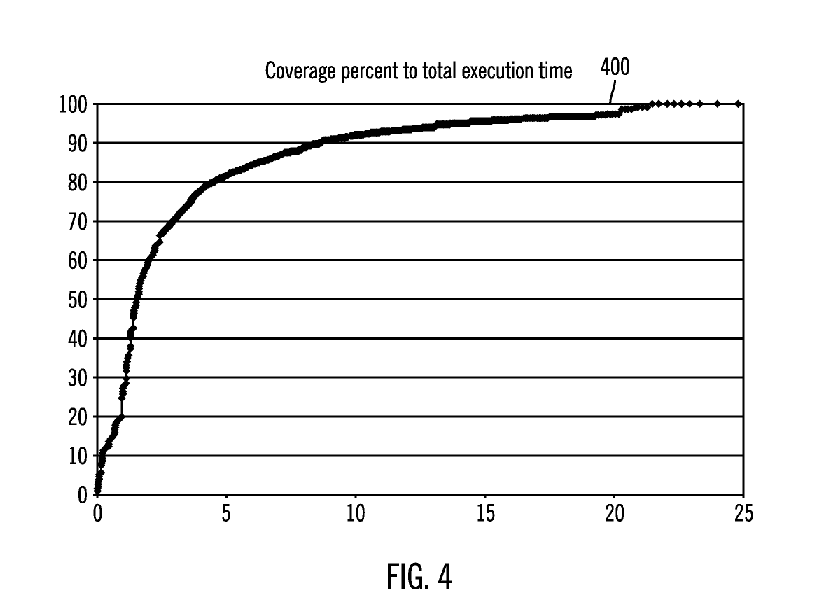

FIG. 4 illustrates a graph 400 of sample test statistics in accordance with certain embodiments. Graph 400 plots a correlation between coverage percentage (vertical axis) and a total running time for tests sorted by execution time of code blocks (horizontal axis). Graph 400 shows that a significant coverage of the code blocks (90%) can be achieved by running a set of tests that executes in around 8 minutes. In order to cover the remaining 10% of the code blocks, a number of long-running tests need to be executed that will run in about 17 minutes, so the “returns” of increased coverage on time invested to run the tests may be deemed low. Based on this information, the test optimization system 110 generates a further reduced test suite 164 that does not provide full coverage, but will execute faster that the original test suite 160 or the optimized test suite 162. The reduced test suite 164 may be used in cases where low-risk changes have to be tested quickly. In certain embodiments, based on this, the test optimization system 110 may stop processing tests on the list as soon as a configurable test coverage goal is reached (block 310). In certain embodiments, the configurable test coverage goal may be a designated code block coverage percentage (e.g., 90% of code blocks should be covered).

In certain embodiments, the test optimization system 110 enables the end user to designate that some tests should always be run. In particular, the test optimization system 110 provides a configuration mechanism that allows the end user to designate some tests as mandatory, and this causes them to remain in the optimized test suite 162 and the reduced test suite 164 unconditionally.

In certain embodiments, the test optimization system 110 handles test failures so that they do not contaminate generated optimized test suite 162 or the reduced test suite 164. While a small number of tests may be allowed to fail without affecting the generated optimized test suite 162 or the reduced test suite 164, some number of failing tests that is over a certain, configurable threshold may indicate a problem with code or execution environment, and the test optimization system 110 stops the optimization process when this threshold is reached.

In certain embodiments, the captured correlations between tests and blocks of code represent information that can be mined and used to improve the development process. The test optimization system 110 may use this information to select and execute tests based on complex criteria, such as the following:
Execute all tests that access data source X
Execute all tests that touch class Y or method Z
Execute all tests that touch methods that contain more than 10 blocks of code

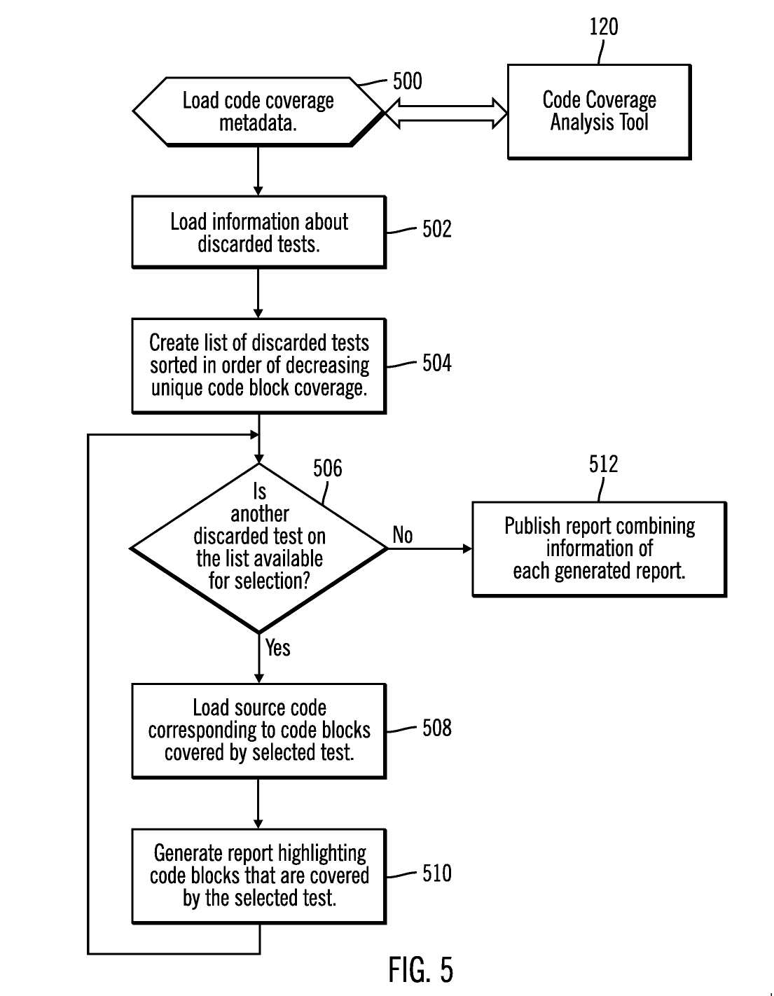

FIG. 5 illustrates logic, in a flow diagram, for reporting discarded test information in accordance with certain embodiments. The test code coverage data may be helpful in understanding how tests can be optimized to make them faster and more relevant. As part of generation of the reduced test suite 164, the test optimization system 110 comes up with a set of tests that is slower than other sets and, yet, does not contribute significant code block coverage. The test optimization system 110 uses the information about these tests to generate a report that developers can use to write better tests.

In FIG. 5, control begins at block 500 with the test optimization system 110 loading code coverage metadata obtained from the code coverage analysis tool 120. The code coverage metadata describes code blocks using functionality provided by the code coverage analysis tool 120.

In block 502, the test optimization system 110 loads information about discarded tests. In block 504, the test optimization system 110 creates a list of discarded tests sorted in order of decreasing unique code block coverage. With this sorting, at the beginning of the list there will be tests that contribute the most coverage, and, if developers were to optimize them to run faster they could appear in the reduced test suite 164 and contribute coverage for code blocks that are not already covered.

In block 506, the test optimization system 110 determines whether another discarded test on the list is available for selection. If so, processing continues to block 508, otherwise, processing continues to block 512.

In block 508, the test optimization system 110 loads the source code corresponding to code blocks covered by the selected test. In certain embodiments, the test optimization system 110 loads the source files that correspond to unique code blocks contributed by the test and turns them into HyperText Markup Language (HTML) files. In block 510, the test optimization system 110 generates a report highlighting code blocks (e.g., code lines) that are covered by the selected test. From block 510, processing continues to block 508.

In block 512, the test optimization system 110 publishes a report combining the information of each generated report (from block 510). In certain embodiments, once all source code is highlighted in this manner, the test optimization system 110 joins the source code together in an HTML report that is then published for analysis by developers. The report will give developers information on what code can be covered by simpler, faster tests in order to increase overall code coverage.

Thus, in certain embodiments, the test optimization system 110 provides dynamic reduction of the test suite size, while maintaining a high level of code coverage. The test optimization system 110 introduces: an automated way to capture information on code coverage that each test contributes; an optimization mechanism that analyzes the test suite, culling from it tests that do not contribute new code coverage or tests that perform too slowly (i.e., if faster versions with similar coverage are available); tuning functionality that allows further reduction of the test suite size by decreasing the percentage of overall code coverage in favor of faster run time; a reporting mechanism that describes to end users which tests were excluded from the test suite and why, allowing the end users to optimize individual tests that were removed due to low coverage or bad performance.

In certain embodiments, the test optimization system 110 captures characteristics (e.g., execution time, specific lines touched by the tests (including recording complete information about all lines touched), etc.). Then, the test optimization system 110 uses this information to remove “redundant” tests (i.e., tests that cover code already covered by other tests) and remove long-running tests/low-value tests (i.e., tests that take a long time to execute and contribute little code coverage that should be further optimized). The test optimization system 110 also is able to set target execution time for the test suite to satisfy quick execution requirements; generate reduced test suites for developers to execute; provide detailed reports on how to improve discarded tests down to specific lines in the code that should be covered; and record detailed code coverage information that allows building test suites satisfying arbitrarily complex criteria.

The test optimization system 110 uses actual code coverage down to an individual code line. The test optimization system 110 also uses other criteria, such as execution time, to not only remove redundancies, but also optimize total execution time. The test optimization system 110 optimizes the test suite with regards to speed (slower redundant tests will be removed).

The test optimization system 110 provides users with a wealth of analysis information that can help with further refinement of the tests. Thus, embodiments focus on length of time of tests in a test suite run. In certain embodiments, the test suite may be re-optimized periodically (e.g., nightly).

The test optimization system 110 combines time and coverage prioritization in the same process and tests are ordered by their execution time right from the beginning, giving faster tests with the highest coverage first. The test optimization system 110 allows users to set a time threshold at which a reduced test suite will be generated (thus satisfying a time requirement while temporarily sacrificing completeness). The test optimization system 110 provides analysis and utility functionality, providing a user with reduced tests suites automatically generated for them periodically and a wealth of data that can be used to select tests suites according to complex timing and coverage criteria.

The test optimization system 110 works with existing tests and uses code coverage and test execution time to build optimized tests suites that perform faster by removing redundant tests and slow tests that contribute little code coverage.

Embodiments provide a coverage-based test suite optimization mechanism that, for each of one or more tests, executes a first test suite on the application, updates a tool to keep track of the code coverage information (i.e., which parts of the application code are covered by each test in the first test suite). Then, a second test suite is constructed by analyzing the test code coverage information and the execution time of each test in the first test suite. Tests are selected and deselected for the second test suite by optimizing execution time against code coverage for the second test suite.

### Additional Embodiment Details

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, solid state memory, magnetic tape or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the embodiments of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational processing (e.g., operations or steps) to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The code implementing the described operations may further be implemented in hardware logic or circuitry (e.g., an integrated circuit chip, Programmable Gate Array (PGA), Application Specific Integrated Circuit (ASIC), etc. The hardware logic may be coupled to a processor to perform operations.

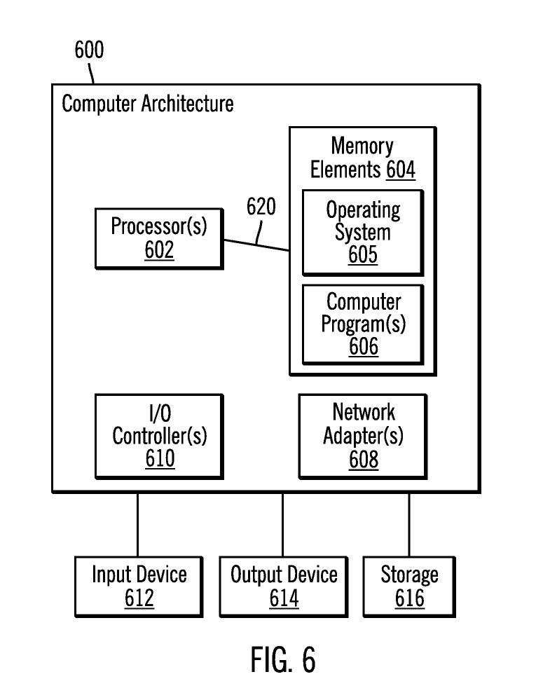

FIG. 6 illustrates a computer architecture 600 that may be used in accordance with certain embodiments. The central server 100 and/or any of the developer machines 170 may implement computer architecture 600. The computer architecture 600 is suitable for storing and/or executing program code and includes at least one processor 602 coupled directly or indirectly to memory elements 604 through a system bus 620. The memory elements 604 may include local memory employed during actual execution of the program code, bulk storage, and cache memories which provide temporary storage of at least some program code in order to reduce the number of times code must be retrieved from bulk storage during execution. The memory elements 604 include an operating system 605 and one or more computer programs 606.

Input/Output (I/O) devices 612, 614 (including but not limited to keyboards, displays, pointing devices, etc.) may be coupled to the system either directly or through intervening I/O controllers 610.

Network adapters 608 may also be coupled to the system to enable the data processing system to become coupled to other data processing systems or remote printers or storage devices through intervening private or public networks. Modems, cable modem and Ethernet cards are just a few of the currently available types of network adapters 608.

The computer architecture 600 may be coupled to storage 616 (e.g., any type of storage device including a non-volatile storage area, such as magnetic disk drives, optical disk drives, a tape drive, etc.). The storage 616 may comprise an internal storage device or an attached or network accessible storage. Computer programs 606 in storage 616 may be loaded into the memory elements 604 and executed by a processor 602 in a manner known in the art.

The computer architecture 600 may include fewer components than illustrated, additional components not illustrated herein, or some combination of the components illustrated and additional components. The computer architecture 600 may comprise any computing device known in the art, such as a mainframe, server, personal computer, workstation, laptop, handheld computer, telephony device, network appliance, virtualization device, storage controller, etc.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The foregoing description of embodiments of the invention has been presented for the purposes of illustration and description. It is not intended to be exhaustive or to limit the embodiments to the precise form disclosed. Many modifications and variations are possible in light of the above teaching. It is intended that the scope of the embodiments be limited not by this detailed description, but rather by the claims appended hereto. The above specification, examples and data provide a complete description of the manufacture and use of the composition of the embodiments. Since many embodiments may be made without departing from the spirit and scope of the invention, the embodiments reside in the claims hereinafter appended or any subsequently-filed claims, and their equivalents.

1. A method for improving a test suite, comprising:
creating, using a processor of a computer, a list of tests in a test suite, sorted in order of increasing run time, wherein multiple tests having a same run time are sorted in order of decreasing code block coverage;
for each test on the list,
determining whether the test covers one or more code blocks not already covered by at least one previously processed test; and
in response to determining that the test does cover one or more code blocks not already covered by the at least one previously processed test, adding the test to an optimized test suite; and
storing the optimized test suite.

2. The method of claim 1, further comprising:
in response to determining that the test covers only blocks already covered by the previously processed test, discarding the test.

3. The method of claim 1, wherein the code blocks that are not already covered are added to a global record, and wherein determining whether the test covers code blocks not already covered by a previously processed test further comprises:
comparing code block identifiers of code blocks of the test with code block identifiers of code blocks stored in the global record.

4. The method of claim 1, wherein the optimized test suite includes tests to cover all code blocks of an application.

5. The method of claim 1, further comprising:
determining whether a test coverage goal has been reached;
in response to determining that the test coverage goal has been reached, adding the test to a list of discarded tests; and
in response to determining that the test coverage goal has not been reached, adding the test to a reduced test suite.

6. The method of claim 5, wherein the reduced test suite includes tests to cover some subset of the code blocks of an application.

7. The method of claim 1, further comprising:
creating a list of discarded tests sorted in order of decreasing unique code block coverage;
for each of the discarded tests,
loading source code corresponding to code blocks covered by the discarded test; and
generating a report highlighting code blocks that are covered by the discarded test; and
publishing a report combining each generated report.

8. The method of claim 1, further comprising:
collecting test code coverage data.

9. A computer program product for improving a test suite, the computer program product comprising:
a computer readable storage medium having computer readable program code embodied therewith, the computer readable program code comprising:
computer readable program code, when executed by a processor of a computer, configured to perform:
creating a list of tests in a test suite, sorted in order of increasing run time, wherein multiple tests having a same run time are sorted in order of decreasing code block coverage;
for each test on the list,
determining whether the test covers one or more code blocks not already covered by at least one previously processed test; and
in response to determining that the test does cover one or more code blocks not already covered by the at least one previously processed test, adding the test to an optimized test suite; and
storing the optimized test suite.

10. The computer program product of claim 9, wherein the computer readable program code, when executed by the processor of the computer, is configured to perform:
in response to determining that the test covers only blocks already covered by the previously processed test, discarding the test.

11. The computer program product of claim 9, wherein the code blocks that are not already covered are added to a global record, and wherein, for determining whether the test covers code blocks not already covered by a previously processed test, the computer readable program code, when executed by the processor of the computer, is configured to perform:
comparing code block identifiers of code blocks of the test with code block identifiers of code blocks stored in the global record.

12. The computer program product of claim 9, wherein the computer readable program code, when executed by the processor of the computer, is configured to perform:
determining whether a test coverage goal has been reached;
in response to determining that the test coverage goal has been reached, adding the test to a list of discarded tests; and
in response to determining that the test coverage goal has not been reached, adding the test to a reduced test suite.

13. The computer program product of claim 9, wherein the computer readable program code, when executed by the processor of the computer, is configured to perform:
creating a list of discarded tests sorted in order of decreasing unique code block coverage;
for each of the discarded tests,
loading source code corresponding to code blocks covered by the discarded test; and
generating a report highlighting code blocks that are covered by the discarded test; and
publishing a report combining each generated report.

14. The computer program product of claim 9, wherein the computer readable program code, when executed by the processor of the computer, is configured to perform:
collecting test code coverage data.

15. A computer system for improving a test suite, comprising:
a processor; and
a storage device coupled to the processor, wherein the storage device has stored thereon a program, and wherein the processor is configured to execute instructions of the program to perform operations, wherein the operations comprise:
creating a list of tests in a test suite, sorted in order of increasing run time, wherein multiple tests having a same run time are sorted in order of decreasing code block coverage;
for each test on the list,
determining whether the test covers one or more code blocks not already covered by at least one previously processed test; and
in response to determining that the test does cover one or more code blocks not already covered by the at least one previously processed test, adding the test to an optimized test suite; and
storing the optimized test suite.

16. The computer system of claim 15, wherein the operations further comprise:
in response to determining that the test covers only blocks already covered by the previously processed test, discarding the test.

17. The computer system of claim 15, wherein the code blocks that are not already covered are added to a global record, and wherein the operations for determining whether the test covers code blocks not already covered by a previously processed test further comprise:
comparing code block identifiers of code blocks of the test with code block identifiers of code blocks stored in the global record.

18. The computer system of claim 15, wherein the operations further comprise:
determining whether a test coverage goal has been reached;
in response to determining that the test coverage goal has been reached, adding the test to a list of discarded tests; and
in response to determining that the test coverage goal has not been reached, adding the test to a reduced test suite.

19. The computer system of claim 15, wherein the operations further comprise:
creating a list of discarded tests sorted in order of decreasing unique code block coverage;
for each of the discarded tests,
loading source code corresponding to code blocks covered by the discarded test; and
generating a report highlighting code blocks that are covered by the discarded test; and
publishing a report combining each generated report.

20. The computer system of claim 15, wherein the operations further comprise:
collecting test code coverage data.
